(19) United States
(12) Patent Application Publication
(10) Pub. No.: US 2025/0249438 A1
(43) Pub. Date: Aug. 7, 2025

(54) PHOTOCATALYST, METHOD OF PREPARING THE SAME, AND CATALYST FILTER AND AIR PURIFICATION SYSTEM INCLUDING THE PHOTOCATALYST

(71) Applicant: Samsung Electronics Co., Ltd., Suwon-si (KR)

(72) Inventors: Min Seok Koo, Suwon-si (KR); Hyun Chul Lee, Suwon-si (KR); Dongjin Ham, Suwon-si (KR); Mijong Kim, Suwon-si (KR); Hyeonsu Heo, Suwon-si (KR); Jonghyun Ha, Suwon-si (KR)

(21) Appl. No.: 19/018,581

(22) Filed: Jan. 13, 2025

(30) Foreign Application Priority Data
Feb. 5, 2024 (KR) 10-2024-0017537

(51) Int. Cl. B01J 21/06; B01D 53/44; B01J 35/39; B01J 35/45; B01J 35/57; B01J 37/08

(52) U.S. Cl. CPC B01J 21/063; B01D 53/44; B01J 35/39; B01J 35/57; B01J 37/08; B01D 2255/20707; B01D 2255/70; B01D 2255/802; B01D 2257/708; B01J 35/45

(57) ABSTRACT

Provided is a photocatalyst including boron oxide; a first metal oxide, wherein the first metal oxide is an oxide of a first metal; and a core including anatase, wherein the boron oxide and the first metal oxide are disposed on a surface of the core, and an oxidation number of at least one of the first metals is +1.

### CROSS-REFERENCE TO RELATED APPLICATION

This application is based on and claims priority to Korean Patent Application No. 10-2024-0017537, filed on Feb. 5, 2024, in the Korean Intellectual Property Office, and all the benefits accruing therefrom under 35 U.S.C. § 119, the contents of which is incorporated by reference herein in its entirety.

### BACKGROUND

### 1. Field

The disclosure relates to a photocatalyst, a method of preparing the same, and a catalyst filter, a catalyst module, and an air purification system that include the photocatalyst.

### 2. Description of the Related Art

In order to remove pollutants in the air, methods of adsorbing and removing gas pollutants by applying an adsorbent (e.g., activated carbon) with a large specific surface area to an air cleaning filter have been commercially used. Such adsorbing and removing methods may cause secondary pollution when the adsorbed gas pollutants are desorbed, or a separate regeneration process such as heating at a high temperature to reuse the adsorbent may be desired. Also, in the presence of moisture, the performance of the adsorbent may rapidly deteriorate.

A photocatalyst is a material capable of inducing oxidation and reduction reactions of electrons and holes that are formed when a catalyst receives light of at least a certain energy and utilizing the reactions to remove gas pollutants. Among such photocatalysts, a TiO₂ photocatalyst uses a method of decomposing gas pollutants by converting gas pollutants into carbon dioxide. The TiO₂ photocatalyst using such a decomposition method may cause rapid recombination of electrons and holes that are generated by light, leading to a decrease in catalytic efficiency, and thus there remains a need for improved photocatalysts.

### SUMMARY

Provided are a photocatalyst and a preparation method of the same, the photocatalyst having enhanced absorption of light in an ultraviolet region and improved removal efficiency and stability of volatile organic compounds (VOCs).

Provided is a catalyst filter including the photocatalyst.

Provided is an air purification system including a catalyst module.

Additional aspects will be set forth in part in the description which follows and, in part, will be apparent from the description, or may be learned by practice of the presented embodiments of the disclosure.

According to an aspect of the disclosure, a photocatalyst includes boron oxide, a first metal oxide, wherein the first metal oxide is an oxide of a first metal; and a core including anatase, wherein the boron oxide and the first metal oxide are disposed on a surface of the core, and an oxidation number of at least one of first metals is +1.

According to another aspect of the disclosure, a method of preparing the photocatalyst includes preparing a first mixture containing a boron-containing precursor, a first metal-containing precursor, and anatase, and heat-treating the first mixture to prepare the photocatalyst.

According to another aspect of the disclosure, a catalyst filter includes a porous ceramic support, and the photocatalyst disposed on a surface of the porous ceramic support.

According to another aspect of the disclosure, a catalyst module includes the catalyst filter, and an energy supply source disposed on the catalyst filter to supply energy to the catalyst filter to activate a catalyst.

According to another aspect of the disclosure, an air purification system includes a supplier configured to supply air containing volatile organic compounds (VOCs); and an air purifier including the catalyst module configured to decompose and remove the VOCs from the air supplied from the supplier and discharge the air from which the VOCs have been decomposed and removed.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram for explaining the structure and operation principle of a photocatalyst according to an embodiment;

FIG. 2A is a graph of intensity (arbitrary units, a.u.) vs. binding energy (electron volts, eV) and shows the results of X-ray photoelectron spectroscopy (XPS) of silver (Ag) in a Ag₂O—B₂O₃/TiO₂ photocatalyst prepared according to Example 1;

FIG. 2B is a graph of intensity (a.u.) vs. binding energy (electron volts, eV) and shows the results of XPS of boron (B) in the Ag₂O—B₂O₃/TiO₂ photocatalyst prepared according to Example 1;

FIGS. 3A and 3B are each a transmission electron microscopy (TEM) image of the Ag₂O—B₂O₃/TiO₂ photocatalyst prepared according to Example 1;

FIG. 4A is a graph of intensity (a.u.) vs. diffraction angle (° 2θ) and shows the results of X-ray diffraction (XRD) analysis for TiO₂ in a Ag₂O—B₂O₃/TiO₂ photocatalyst (at a heat treatment temperature of 450° C.) prepared according to Example 1;

FIG. 4B is a graph of intensity (a.u.) vs. diffraction angle (° 2θ) and shows results of XRD analysis of TiO₂ in a Ag₂O—B₂O₃/TiO₂ photocatalyst (at a heat treatment temperature of 620° C.) prepared according to Comparative Example 4;

FIG. 5A is a graph of emission intensity (a.u.) vs. wavelength (nanometers, nm) and shows an emission spectrum of each of the Ag₂O—B₂O₃/TiO₂ photocatalyst (at a heat treatment temperature of 450° C.) prepared according to Example 1, a TiO₂ photocatalyst prepared according to Comparative Example 1, a Ag₂O/TiO₂ photocatalyst prepared according to Comparative Example 2, and a B₂O₃/TiO₂ photocatalyst prepared according to Comparative Example 3;

FIG. 5B is a graph of emission intensity (a.u.) vs. wavelength (nm) and shows an emission spectrum of each of a Ag₂O—B₂O₃/TiO₂ photocatalyst (at a heat treatment temperature of 450° C.) prepared according to Example 1, a TiO₂ photocatalyst prepared according to Comparative Example 1, and a Ag₂O—B₂O₃/TiO₂ photocatalyst (at a heat treatment temperature of 620° C.) prepared according to Comparative Example 4;

FIG. 6A is a graph of Kubelka-Munk (K-M) function (a.u.) vs. wavelength (nm) of each of the Ag₂O—B₂O₃/TiO₂ photocatalyst (at a heat treatment temperature of 450° C.) prepared according to Example 1, the TiO₂ photocatalyst prepared according to Comparative Example 1, the Ag₂O/TiO₂ photocatalyst prepared according to Comparative Example 2, and the B₂O₃/TiO₂ photocatalyst prepared according to Comparative Example 3;

FIG. 6B is a graph of K-M function (a.u.) vs. wavelength (nm) of each of the Ag₂O—B₂O₃/TiO₂ photocatalyst (at a heat treatment temperature of 450° C.) prepared according to Example 1, and the Ag₂O—B₂O₃/TiO₂ photocatalyst (at a heat treatment temperature of 620° C.) prepared according to Comparative Example 4;

FIG. 7 is a schematic view of a catalyst filter according to an embodiment;

FIG. 8A is a schematic view of a catalyst module according to an embodiment;

FIG. 8B is a schematic view of a chamber in which the catalyst module of FIG. 8A is mounted;

FIG. 9 is a schematic view of an air purification system according to an embodiment;

FIG. 10 is a schematic view of a gas supply unit of a second supplier which is an example of a supplier of the air purification system FIG. 9;

FIG. 11 is a schematic view of a gas supply unit of the air purification system of FIG. 9; and

FIG. 12 is a schematic view of a reactor included in a gas supply unit of the air purification system of FIG. 9.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figure, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept described hereinbelow may have various modifications and various embodiments, example embodiments will be illustrated in the drawings and more fully described in the detailed description. The present inventive concept may, however, should not be construed as limited to the example embodiments set forth herein, and rather, should be understood as covering all modifications, equivalents, or alternatives falling within the scope of the present inventive concept.

The terms as used herein are for the purpose of describing particular embodiments only, and are not intended to be limiting the present inventive concept. An expression used in the singular encompasses the expression of the plural, unless it has a clearly different meaning in the context.

The expression “at least one” or “one or more” used in front of components in the present specification is meant to supplement a list of all components means, and does not imply to supplement individual components of the description. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. Thus, reference to “an” element in a claim followed by reference to “the” element is inclusive of one element and a plurality of the elements. The term “combination” used in the present specification includes, unless otherwise described, a mixture, an alloy, a reaction product, and the like. The term “include” used in the present specification does not exclude other components unless otherwise described, and means that other components may be further included. The terms such as “first,” “second,” etc. used in the present specification may be used to distinguish one component from another without indicating order, quantity, or importance. Unless otherwise indicated or otherwise clearly described by context in the present specification, components should be construed to include both the singular and the plural. The expression “or” includes, unless otherwise specified, the meaning of “and/or”.

It will be understood that when an element is referred to as being “on” another element, it can be directly on the other element or intervening elements may be present therebetween. In contrast, when an element is referred to as being “directly on” another element, there are no intervening elements present.

Throughout the present specification, the term “an embodiment” or the like means that a specific component described in connection with embodiments is included in at least one embodiment described herein, and that the specific component may or may not be present in other embodiments. In addition, components described herein should be construed as being possibly combined in any suitable manner in the various embodiments.

Unless otherwise stated, all percentages, parts, ratios, and the like are by weight. In addition, when an amount, concentration, or other values or parameters are given in a range, a preferable range, or a list of preferable upper limits or preferable lower limits, it is to be understood that, regardless of whether the range is separately disclosed, all ranges formed from any upper range limits, or preferred values and any lower range limits, or any pair of preferred values should be specifically disclosed.

When a range of numerical values is stated in the present specification, unless otherwise stated, the range is intended to include the endpoints and all integers and fractions within the range. The scope of the disclosure is intended not to be limited by specific values referred when defining the range.

Unless otherwise specified, the unit “part by weight” refers to a weight ratio between each component, and the unit “part by mass” refers to a value obtained by converting a weight ratio between each component into a solid content.

The expression “about” used in the present specification includes a value stated herein, and also includes a value within an acceptable range of deviations of a specific value determined by those skilled in the art means in consideration of errors associated with corresponding measurement and measurement of specific quantity (i.e., the limit of the measuring system). For example, the expression “about” may include a value within one or more standard deviations, or a value ±30%, ±20%, ±10%, or ±5% of a specified value. All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.).

Unless otherwise defined, all terms (including technical and scientific terms) used in the present specification have the same meaning as commonly understood by those skilled in the art to which the disclosure belongs to. In addition, terms such as terms defined in commonly used dictionaries should be interpreted to have meanings consistent with the meaning in the related art and the disclosure, and should not be construed as being idealized. Alternatively, the terms should not be interpreted in an excessively formal sense.

Exemplary embodiments are described with reference to cross-sectional views that are schematic diagrams of idealized embodiments. Accordingly, the appearance of examples may vary, for example, as a result of manufacturing techniques and/or tolerances. Therefore, embodiments described herein should not be construed as being limited to the specific shape of the regions described herein, but should include, for example, variations in shape occurring during manufacturing. For example, regions illustrated or described as flat regions may generally have rough and/or non-linear characteristics. Also, an illustrated acute angle may be round. Therefore, regions illustrated in drawings are schematic in nature, and shapes thereof are not intended to illustrate the precise shape of the regions and are not intended to limit the scope of the claims.

Hereinafter, a photocatalyst, a catalyst filter, a catalyst module, and an air purification system that include the photocatalyst will be described in more detail in embodiments.

A photocatalyst according to an embodiment includes: boron oxide; a first metal oxide, wherein the first metal oxide is an oxide of the first metal; and a core including anatase TiO₂ (i.e., anatase), wherein the boron oxide and the first metal oxide may be disposed on a surface of the core.

The boron oxide, together with the first metal oxide, may serve to prevent recombination of electrons and holes that are excited by light. Accordingly, active radicals, such as O₂ radicals that can be generated through a reduction reaction between the electrons and oxygen, and OH radicals that can be generated through an oxidation reaction between the holes and water, may be effectively generated, and removal of contaminants caused by such active radicals may be effectively achieved.

In an embodiment, the boron oxide may include B₂O₃.

According to one or more embodiments, the boron oxide may be disposed on the surface of the core, in the form of a boron oxide layer covering at least a portion of the surface of the core. For example, at least a portion of the surface of the core may be coated with the boron oxide layer.

According to one or more embodiments, the boron oxide layer may include crystals of boron oxide produced as a result of melting of the boron oxide. In an aspect, the boron oxide layer comprises crystalline boron oxide. A liquid boron oxide produced by melting at least a portion of the boron oxide may be crystallized to form the crystalline boron oxide.

According to one or more embodiments, on the surface of the boron oxide layer, the first metal oxide may be disposed. For example, the boron oxide layer may be disposed between the core and the first metal oxide. The boron oxide layer disposed between the core and the first metal oxide may serve to improve the binding force between the core and the first metal oxide. In this regard, the supporting strength of the first metal oxide is improved, and accordingly, the photocatalyst may have excellent stability.

According to one or more embodiments, the core may further include the boron oxide. For example, the boron oxide included in the core may include crystals (e.g., crystalline boron oxide) that are crystallized after liquid boron oxide generated as a result of melting of the boron oxide penetrates into the core. The boron oxide penetrating into the core as described above may improve light efficiency of the core, for example, efficiency of forming electrons and holes that are generated in the presence of light, thereby improving contaminant removal performance of the photocatalyst.

An amount of the boron oxide may be, based on 100 parts by weight of the core, in a range of about 0.1 parts by weight to about 5.0 parts by weight, about 0.1 parts by weight to about 3.0 parts by weight, about 0.1 parts by weight to about 2.0 parts by weight, about 0.1 parts by weight to about 1.5 parts by weight, about 0.1 parts by weight to about 1.2 parts by weight, about 0.5 parts by weight to about 5.0 parts by weight, about 0.5 parts by weight to about 3.0 parts by weight, about 0.5 parts by weight to about 2.0 parts by weight, about 0.5 parts by weight to about 1.5 parts by weight, about 0.5 parts by weight to about 1.2 parts by weight, about 0.8 parts by weight to about 5.0 parts by weight, about 0.8 parts by weight to about 3.0 parts by weight, about 0.8 parts by weight to about 2.0 parts by weight, about 0.8 parts by weight to about 1.5 parts by weight, or about 0.8 parts by weight to about 1.2 parts by weight. When the amount of the boron oxide is within the ranges above, recombination of the electrons and holes that are excited by light may be effectively prevented without deteriorating light absorption performance of the core.

The first metal oxide may serve to enhance activity of the photocatalyst by increasing an optical absorption rate of the photocatalyst and increasing active radical generation efficiency by scavenging the electrons excited by light.

An oxidation number of at least one of first metals included in the first metal oxide may be +1. The first metal oxide, which is an oxide of the first metal having an oxidation number of +1, is unstable in the air, and thus electron transfer from the surface of the core to the first metal oxide may be easily performed.

For example, the first metal may include copper, platinum, gold, silver, zinc, manganese, or a combination thereof.

According to an embodiment, the first metal oxide may include an oxide of silver.

According to one or more embodiments, the first metal oxide may include Cu₂O, Pt₂O, Au₂O, Ag₂O, Zn₂O, Mn₂O, or a combination thereof.

According to an embodiment, the first metal oxide may include Ag₂O. Ag₂O is a p-type semiconductor catalyst, and may induce a highly efficient reduction reaction.

An amount of the first metal oxide may be, based on 100 parts by weight of the core, in a range of about 0.1 parts by weight to about 5.0 parts by weight, about 0.1 parts by weight to about 3.0 parts by weight, about 0.1 parts by weight to about 2.0 parts by weight, about 0.1 parts by weight to about 1.5 parts by weight, about 0.1 parts by weight to about 1.2 parts by weight, about 0.5 parts by weight to about 5.0 parts by weight, about 0.5 parts by weight to about 3.0 parts by weight, about 0.5 parts by weight to about 2.0 parts by weight, about 0.5 parts by weight to about 1.5 parts by weight, about 0.5 parts by weight to about 1.2 parts by weight, about 0.8 parts by weight to about 5.0 parts by weight, about 0.8 parts by weight to about 3.0 parts by weight, about 0.8 parts by weight to about 2.0 parts by weight, about 0.8 parts by weight to about 1.5 parts by weight, or about 0.8 parts by weight to about 1.2 parts by weight. When the amount of the first metal oxide is within the ranges above, the optical absorption rate of the photocatalyst may be improved.

The core of the photocatalyst may include anatase TiO₂. Accordingly, various chemical reactions (e.g., various oxidation reactions, etc.) for contaminant removal may be effectively achieved.

The first metal oxide and the core may independently be in the form of a particle, a wire, a cluster, a crystal, or a combination thereof. For example, the first metal oxide and the core may independently be in the form of a particle or a crystal. Such particle or crystal may each independently have a spherical shape, a tube shape, a rod shape, a fiber shape, a sheet shape, or a combination thereof, and may have the same or different shapes to control light absorption efficiency of the photocatalyst.

According to one or more embodiments, in the photocatalyst, the particle of the first metal oxide may be disposed in the form of an island on the surface of the particle of the core, optionally with the boron oxide layer between the core and first metal oxide.

According to one or more embodiments, the particle (e.g., particles) of the first metal oxide may be a primary particle (e.g., primary particles) having a first size, and the particle (e.g., particles) of the core may be a primary particle (e.g., primary particles) having a second size or a secondary particle (e.g., secondary particles) having a third size. For example, the first size, which is an average particle diameter of the particles of the first metal oxide, may be in a range of about 5 nanometers (nm) to about 10 nm, about 6 nm to about 9 nm, or about 7 nm to about 8 nm. When the average particle diameter of the particles of the first metal oxide is within the ranges above, the particles of the first metal oxide may be easily disposed on the surface of the core particles, thereby improving activity of the photocatalyst. In an aspect, the average particle diameter may be calculated by analyzing the particle diameters of the particles by scanning electron microscopy. An average may be mean or median. For example, the second size, which is an average particle diameter of the primary particles of the core, may be in a range of about 0.1 nm to about 20 nm, about 1 nm to about 10 nm, or about 3 nm to about 7 nm. The third size, which is an average particle diameter of the secondary particles of the core in which the primary particles of the core are aggregated, may be in a range of about 10 nm to about 200 nm, about 30 nm to about 150 nm, or about 50 nm to about 100 nm. Within the ranges above, the particles of the first metal oxide may obtain a specific surface area of a desired level.

According to one or more embodiments, the specific surface area of the primary particles or secondary particles of the core may each be about 100 square meters per gram (m²/g) or greater. For example, the specific surface area of the primary particles or secondary particles of the core may each be in a range of about 100 m²/g to about 500 m²/g, about 100 m²/g to about 450 m²/g, about 100 m²/g to about 400 m²/g, about 100 m²/g to about 350 m²/g, about 100 m²/g to about 300 m²/g, about 100 m²/g to about 250 m²/g, or about 100 m²/g to about 230 m²/g. When the specific surface area of the primary particles or secondary particles of the core is within these ranges, an adsorption area of volatile organic compounds (VOCs) may be widened, and thus removal efficiency of the VOCs may increase.

The photocatalyst may be then used for decomposition and removal of the VOCs. In an aspect, the photocatalyst is effective for decomposition and removal of the VOCs. In this regard, the photocatalyst may not generate ozone.

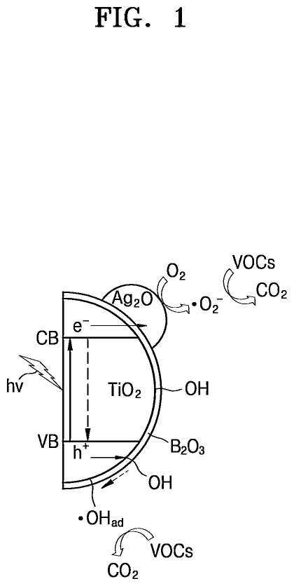

FIG. 1 is a schematic diagram for explaining the structure and operation principle of the photocatalyst according to an embodiment.

Referring to FIG. 1, on the surface of the core including anatase TiO₂, boron oxide (e.g., B₂O₃) and the first metal oxide (e.g., Ag₂O) are disposed. The boron oxide disposed on the surface of the core is in the form of a boron oxide layer covering at least a portion of the surface of the core, and the first metal oxide is disposed on the boron oxide layer surface. That is, the boron oxide layer is disposed between the core including the anatase TiO₂ and the first metal oxide.

When the surface of the core including anatase TiO₂ is irradiated with light (ultraviolet) energy greater than band gap energy, electrons are transferred from a valence band to a conductive band and pairs of electrons (e−) and holes (h+) may be generated. Holes h+ generated in the valence band may contribute to an oxidation reaction. For example, holes h+ may react with water molecules adsorbed on the surface to generate hydroxyl radicals (OH), or may oxidize organic substances, e.g., VOCs, through a direct reaction. Electrons e-generated in the conduction band may cause a reduction reaction of oxygen molecules to form superoxide ions (O₂—), and through several additional reactions, may generate hydroxyl radicals OH. By the hydroxyl radicals OH generated by the holes h+ and electrons e−, the VOCs may be decomposed into carbon dioxide and water.

A method of preparing the photocatalyst according to an embodiment may include: preparing a first mixture containing a boron-containing precursor, a first metal-containing precursor, and anatase TiO₂; and heat-treating the first mixture to prepare the photocatalyst.

According to an embodiment, the boron-containing precursor may include boron oxide (e.g., B₂O₃).

According to one or more embodiments, the first metal-containing precursor may include nitrate of the first metal, copper nitrate, etc. For example, the first metal-containing precursor may include AgNO₃, Cu(NO₃)₂, etc.

The preparing of the first mixture may be performed at a temperature in a range of about 50° C. to about 200° C., about 50° C. to about 150° C., about 50° C. to about 130° C., about 80° C. to about 200° C., about 80° C. to about 150° C., or about 80° C. to about 130° C.

The heat-treating of the first mixture may be performed at 500° C. or less. When the temperature at which the first mixture is heat-treated is within the ranges above, a crystalline phase of the anatase TiO₂ included in the first mixture is substantially maintained (i.e., not changed to a rutile crystalline phase) even after the heat treatment, and accordingly, the photocatalyst including the anatase TiO₂ may be prepared.

According to one or more embodiments, the heat-treating of the first mixture may comprise heating at a temperature in a range of about 450° C. to about 500° C., about 460° C. to about 490° C., or about 470° C. to about 480° C. For example, when the boron-containing precursor includes boron oxide and the first mixture is heat-treated at the temperature ranges above,
i) the crystalline phase of the anatase TiO₂ included in the first mixture may be substantially maintained (i.e., not changed to the rutile crystalline phase) even after the heat treatment, and
ii) a liquid boron oxide produced by melting at least a portion of the boron oxide may be crystallized to cover at least a portion of the surface of the core including the anatase TiO₂ to form a boron oxide layer covering the at least the portion of the surface of the core.

The boron oxide layer thus formed may improve the binding force between the core including the anatase TiO₂ and the first metal oxide to increase the supporting strength of the first metal oxide, thereby improving the stability of the photocatalyst.

Also, when the first mixture is heat-treated at the temperature ranges described above, at least a portion of the liquid boron oxide may penetrate into the core. Consequently, the core may further include, in addition to the anatase TiO₂, crystals of the crystallized boron oxide produced as a result of the melting of the boron oxide. Accordingly, the light efficiency of the core, e.g., the efficiency of forming holes and electrons in the presence of light, may be improved, thereby improving the contaminant removal performance of the photocatalyst.

A catalyst filter according to an embodiment may include: a porous ceramic support; and the photocatalyst disposed on a surface of the porous ceramic support.

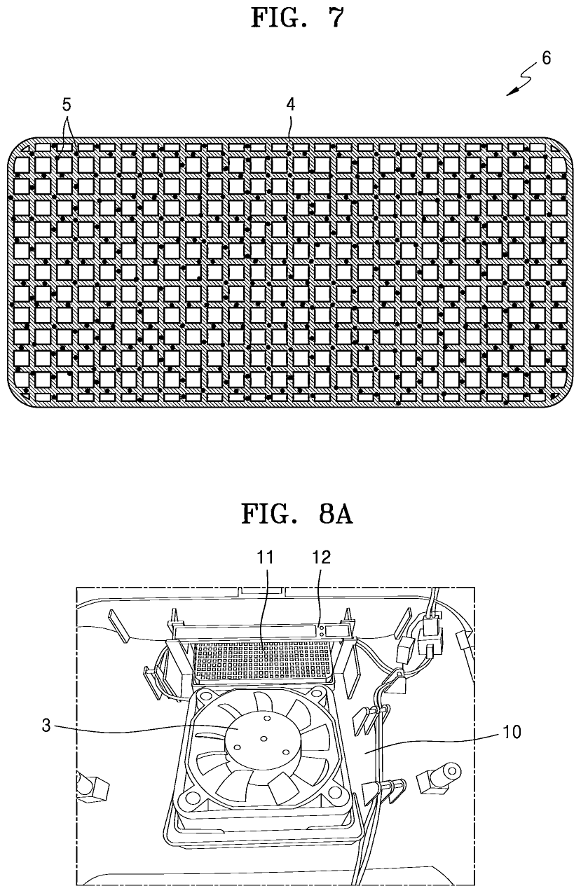

FIG. 7 is a schematic view of a catalyst filter according to an embodiment.

Referring to FIG. 7, a catalyst filter 6 includes a porous ceramic support 4 and particles or particle aggregates 5 of the photocatalyst, wherein the particles or particle aggregates 5 are applied onto the surface of the porous ceramic support 4. The porous ceramic support 4 may have a relatively high strength and a relatively large specific surface area, thereby increasing the activity of the photocatalyst. Also, the porous ceramic support 4 may maintain the shape thereof even under external environments such as strong acid in high temperature and strong wind, and may reduce pressure loss due to improved air permeability.

The porous ceramic support 4 may have a honeycomb structure. The cross section thereof may have various shapes, such as a circle, an oval, a rectangle, a square, and the like. The porous ceramic support 4 may have a cylindrical shape, a cuboid shape, or a cube shape, each having a height and a diameter of several millimeters (mm) or several tens of millimeters (mm), but embodiments are not limited thereto.

For example, the porous ceramic support 4 may have a honeycomb structure having about several hundred square cells per inch. Through the square cells of the porous ceramic support 4, air containing the VOCs may flow into the porous ceramic support 4. For example, the square cells may have a size of several hundred cells per square inch (cpsi), but embodiments are not limited thereto.

The porous ceramic support 4 may include a magnesium oxide, a silicon oxide, and an aluminum oxide, in an amount of about 50% or greater. The porous ceramic support 4 may further include an alkali oxide substance. Examples of the alkali oxide substance may include Li₂O, Na₂O, K₂O, the like, or a combination thereof. The porous ceramic support 4 further including the alkali oxide substance may maintain the shape of the catalyst filter 6 without thermal deformation even at a high temperature. The porous ceramic support 4 may be a single laminate, a multi layered laminate, or a single structure.

A catalyst module according to one or more embodiment may include: the catalyst filter; and an energy supply source disposed on the catalyst filter to supply energy to activate the photocatalyst.

The energy supply source may include at least one of a light energy supply source, an electrical energy supply source, an ion energy supply source, or a heat energy supply source. The light energy supply source may supply light energy in a visible light band from ultraviolet ray. The ion energy supply source may supply plasma. The heat energy supply source may supply infrared ray as heat energy. The energy supply source may include an ultraviolet light-emitting diode (UV-LED). For example, the UV-LED may be an ultraviolet A (UVA) LED (UVA-LED), an ultraviolet B (UVB) LED (UVB-LED), an ultraviolet C (UVC) LED (UVC-LED), or a combination thereof.

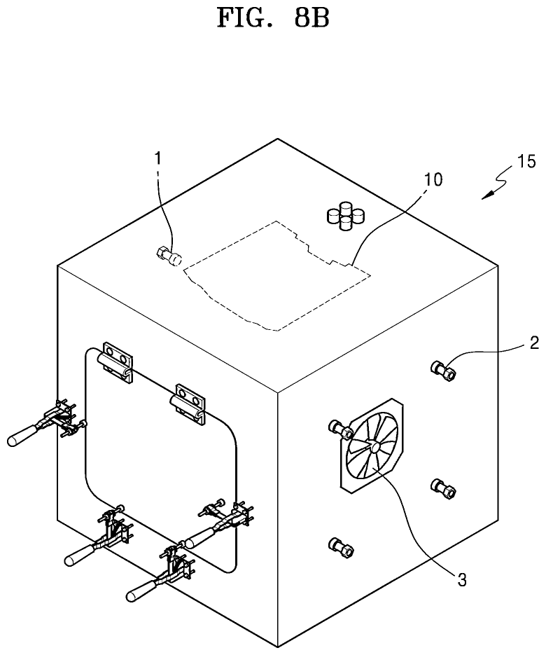

FIG. 8A is a schematic view of the catalyst module 10 according to an embodiment.

Referring to FIG. 8A, the catalyst module 10 includes: the catalyst filter 11 in which a surface of the support is coated with particles or particle aggregates of the photocatalyst; and a light emitter 12 disposed on the catalyst filter 11 to irradiate light for catalyst activation. The light emitter 12 may include a light source array including a single light source or a plurality of light sources. The light emitter 12 may include a substrate, a light-emitting device provided on the substrate, and a capsule sealing and protecting the light-emitting device. The light-emitting device may be a UV-LED, or may include a UV-LED. The substrate may include a control unit, e.g., a circuit unit, for controlling operation of the light-emitting device. The capsule may be formed on the substrate, and may be provided to cover the entire light-emitting device on the substrate. The capsule may be formed of a material that is transparent to light emitted from the light-emitting device. The catalyst module 10 may further include a circulation fan 3 disposed toward the opposite surface of the catalyst filter 11 on which the light emitter 12 is disposed. The light emitter 12 and the circulation fan 3 may be connected to a power source. When the catalyst module 10 operates, the light emitter 12 emits light onto the surface of the catalyst filter 11 facing the light emitter 12, and the catalyst filter 11 absorbs the emitted light to form an activated photocatalyst layer on the surface. The activated catalyst layer may decompose and remove the VOCs by oxidation and reduction reaction as described with reference to FIG. 1.

FIG. 8B is a schematic view of a chamber in which the catalyst module of FIG. 8A is mounted. FIG. 8B shows the chamber in which the catalyst module 10 is mounted, wherein a gas inlet 1 and a gas outlet 2 are installed on one side and the other side parallel to the one side, respectively, and the circulation fan 3 is located on the other side where the gas outlet 2 is installed.

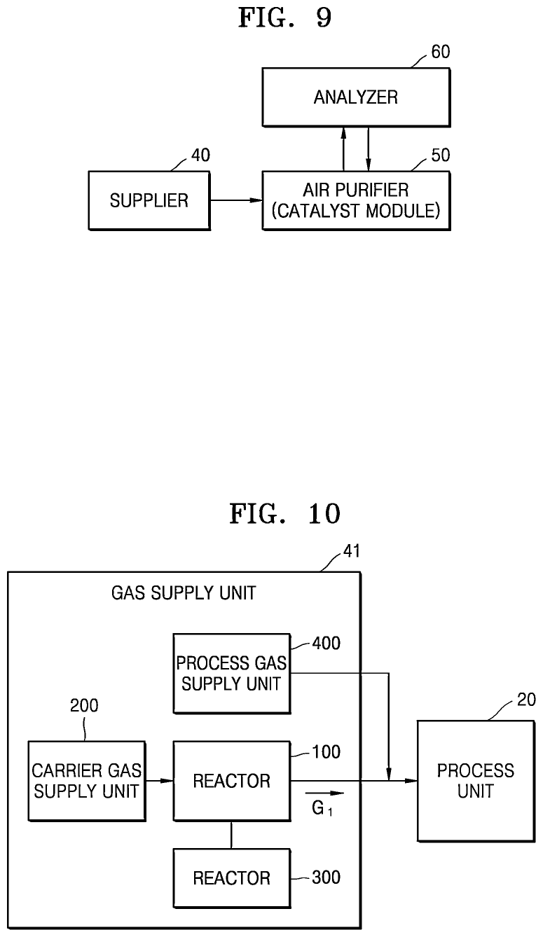

FIG. 9 is a schematic view of an air purification system according to an embodiment.

Referring to FIG. 9, an air purification system includes: a supplier 40 configured to supply air containing VOCs; and an air purifier 50 including the catalyst module configured to decompose and remove the VOCs from the air supplied from the supplier 40, and discharge the air from which the VOCs have been decomposed and removed. The air purification system may further include an analyzer 60 for determining types and measuring concentration of the VOCs present in the air purifier 50. The analyzer 60 may be connected to the air purifier 50 for circulation. Examples of the analyzer 60 include an IR analyzer, a light deVOCflection spectrometer, and the like. The air purifier 50 may correspond to the chamber of FIG. 8B.

The supplier 40 may include: a first supplier for directly supplying air containing VOCs; and a second supplier configured to supply VOCs by mixing and vaporizing carrier gas and process gas.

The VOCs may include gaseous formaldehyde, gaseous ammonia, gaseous acetaldehyde, gaseous acetic acid, gaseous toluene, or a combination thereof.

The first supplier may include: a gas supply unit configured to supply gas having a constant concentration; and a control unit for detecting a gas flow discharged from the gas supply unit and adjusting an amount of the gas. The gas supplied by the first supplier may be gaseous ammonia, gaseous acetaldehyde, gaseous acetic acid, and gaseous toluene.

The second supplier will be described in detail below.

FIG. 10 is a schematic view of a gas supply unit of the second supplier which is an example of the supplier of the air purification system of FIG. 9.

Referring to FIG. 10, the second supplier includes: a gas supply unit 41 configured to supply reaction gas G₁ having a constant concentration; and a process unit 20 for performing a predetermined process by using the reaction gas G₁ supplied from the gas supply unit 41. In an embodiment, the gas supply unit 41 may utilize a solid-type reactant M to supply gaseous-type reaction gas G₁.

The process unit 20 may be any apparatus capable of performing physical and chemical processes by receiving the reaction gas G₁ from the gas supply unit 41. In an embodiment, the process unit 20 may be used in a production apparatus that performs a semiconductor production process or a display production process, such as an etching process or a deposition process, by receiving the reaction gas G₁ having a constant concentration. In addition, the process unit 20 may be used in an experimental apparatus for determining the contaminant removal, i.e., the degree of contaminant removal by receiving the reaction gas G having a constant concentration. However, the disclosure is not limited thereto, and the process unit 20 may be applied to any apparatus capable of performing a subsequent process after receiving the reaction gas G₁ having a constant concentration.

To continuously supply the gaseous-type reaction gas G₁ having a constant concentration to the process unit 20 as described above, the gas supply unit may accommodate the gaseous-type reactive gas G₁ having a constant concentration. In this case, since the form of the reaction gas G₁ accommodated in the gas supply unit is a gas type, the volume of the gas supply unit 41 may be rapidly increased. Since the reactant M accommodated in the gas supply unit 41 according to an embodiment is in a solid form, the total volume of the gas supply unit 41 may be reduced. Meanwhile, the concentration of the reaction gas G₁ discharged from the gas supply unit 41 in the process of converting the solid-type reactant M into the gaseous-type reaction gas G₁ may not be constant. To convert the solid-type reactant M into the gaseous-type reaction gas G₁ and to maintain the constant concentration of the reaction gas G₁ discharged from the gas supply unit 41, the gas supply unit of FIG. 10 may be utilized. In an aspect, the gas supply unit 41 may comprise a reactor 100, another reactor 300, and a process gas supply unit 400.

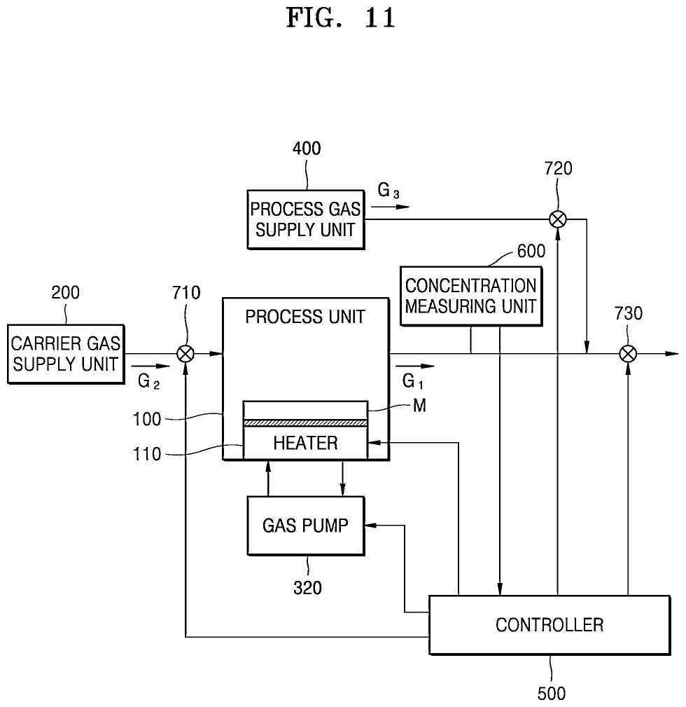

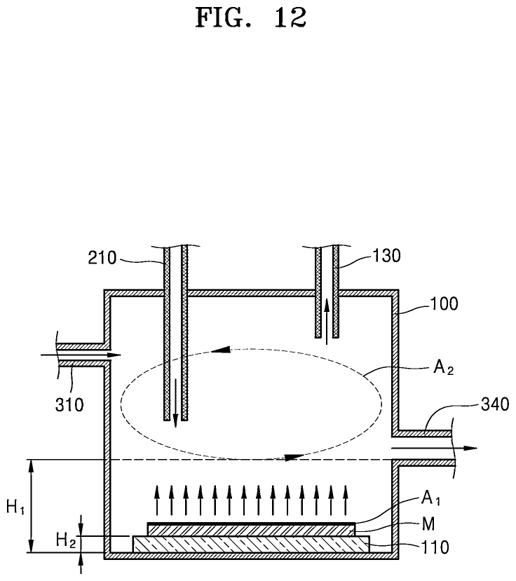

Referring to FIGS. 11 and 12, the gas supply unit according to an embodiment includes: a reactor 100 accommodating a solid-type reactant M; a heater 110 for applying heat to the reactant M; a pumping gas outlet unit 340 for supplying reaction gas G₁ to a process unit 20; a carrier gas supply unit 200; a gas pump 320 for applying a predetermined pumping pressure to the reactor 100; a process gas supply unit 400; a controller 500; and a concentration measuring unit 600.

The reactor 100 may be an accommodating unit that accommodates the reactant M and provides a space for generating reaction gas G₁ in gas form by using the solid-type reactant M. In an embodiment, the solid-type reactant M accommodated in the reactor 100 may be any suitable material capable of being vaporized by heat supplied from the heater 110. The reactant M according to an embodiment may be provided in powder form to be easily vaporized. For example, the reactant M may be any one of para (p)-formaldehyde in powder form, a solid-phase volatile material, or a liquid-phase volatile material. As shown in FIG. 12, a gas discharging unit 130 where the reaction gas G₁ may be discharged may be disposed on an upper portion of the reactor 100. In addition, on a side surface of the reactor 100, a pumping gas inlet unit 310 and the pumping gas outlet unit 340, which are to be described below, through which pumping gas may flow in or flow out, respectively. However, the disclosure is not limited thereto, and the arrangement of the gas discharging unit 130, the pumping gas inlet unit 310, and the pumping gas outlet unit 320 may vary depending on the type of the reaction gas G1 and the pumping gas.

Referring to FIG. 11, the heater 110 may be a heating source to change the reactant M to the reaction gas G₁ by applying heat to the reactant M. In an embodiment, the heater 110 may be disposed on a bottom portion of the reactor 100, and the reactant M may be disposed on an upper portion of the heater 110. For example, the heater 110 may be a hot plate capable of uniformly applying heat to the reactant M disposed on an upper portion of the heater 110. However, the disclosure is not limited thereto, and any suitable heating apparatus capable of applying heat to the reactant M may be disposed. The heating of the heater 110 according to an embodiment may be controlled by the controller 500 to be described below.

The carrier gas supply unit 200 may supply the carrier gas G₂ for transferring the reaction gas G₁ discharged from the reactor 100 to the process unit 20. The carrier gas G₂ according to an embodiment may include inert gas that does not chemically react with the reaction gas G₁. For example, the carrier gas G₂ may include one or more of nitrogen, oxygen, or air. As shown in FIG. 12, a carrier gas inlet unit 210 through which the carrier gas G₂ may flow in may be disposed on an upper portion of the reactor 100. A first opening/closing valve 710 (as shown in FIG. 11) for blocking and releasing the supply of the carrier gas G₂ may be disposed between the carrier gas supply unit 200 and the carrier gas inlet unit 210. The opening and closing of the first opening/closing valve 710 may be controlled by the controller 500 to be described below. For example, when heat is applied to the reactant M by using the heater 110, the first opening/closing valve 710 may be controlled to be closed until the concentration of the reaction gas G₁ exceeds a predetermined target concentration. After the concentration of the reaction gas G₁ exceeds a predetermined target concentration, the first opening/closing valve 710 may be opened. Here, the carrier gas G₂ may flow into the reactor 100.

The gas pump 320 may apply a predetermined pumping pressure to the reactor 100. In an embodiment, the gas pump 320 may relatively uniformly adjust the concentration of the reaction gas G₁ disposed inside the reactor 100 by applying a predetermined pumping pressure to the reactor 100. According to an embodiment, as shown in FIG. 12, the heater 110 is disposed at a bottom portion of the reactor 100, and the solid-type reactant M may receive heat from the heater 110. Accordingly, the concentration of the reaction gas G₁ sensed in a bottom portion of the reactor 100 may be higher than the concentration of the reaction gas G₁ sensed in an upper portion of the reactor 100. Here, the concentration of the reaction gas G₁ discharged through the gas discharging unit 130 may not be constant.

The gas pump 320 according to an embodiment may circulate the reaction gas G₁ by applying a pumping pressure to the upper portion of the reactor 100. Here, in the upper portion where the reaction gas G₁ circulates, the concentration of the reaction gas G₁ may be relatively uniform. For example, the interior of the reactor 100 may be divided into an area A₁ with a non-uniform concentration of the reaction gas and an area A₂ with a uniform concentration of the reaction gas.

In an embodiment, on the reactor 100, the pumping gas inlet unit 310 where the pumping gas supplied from the gas pump 320 flows in and the pumping gas outlet unit 340 pumping gas where the pumping gas flows out may be disposed. Here, as shown in FIG. 12, the pumping gas outlet unit 340 may be disposed at a first height H₁ from the bottom surface of the reactor 100, and the heater 110 may be disposed at a second height H₂ from the bottom surface of the reactor 100, wherein the first height H₁ may be disposed to exceed the second height H₂. Accordingly, in the area up to the first height H₁ at which the pumping gas outlet unit 340 is disposed, the area A1 with a non-uniform concentration of the reaction gas may be formed. That is, in the area A1 with a non-uniform concentration of the reaction gas, the solid-type reactant M may be converted into the reaction gas G₁ by receiving heat, and thus the concentration of the reaction gas G₁ may vary depending on the position. Meanwhile, in the area exceeding the first height H₁ at which the pumping gas outlet unit 340 is disposed, the area A₂ with a uniform concentration of the reaction gas may be formed. That is, in the area A1 with a non-uniform concentration of the reaction gas, the reaction gas G₁ may circulate by a pumping pressure applied by the gas pump 320 so that the concentration of the reaction gas G₁ may be maintained relatively uniform according to the position. Therefore, the reaction gas G₁ having a constant concentration may be discharged through the gas discharging unit 130 disposed in the area A₂ with a uniform concentration of the reaction gas.

In addition, according to an embodiment, the pumping pressure of the gas pump 320 may be controlled by the controller 500. In an embodiment, the controller 500 may adjust the pumping pressure according to a change in the concentration of the reaction gas G1 after receiving the confirmed concentration of the reaction gas G1 from the concentration measuring unit 600 which will be described below. For example, when the concentration of the reaction gas G1 discharged from the reactor 100 changes, the controller 500 increases the pumping pressure to increase the circulation of the reaction gas G1, thereby adjusting the concentration of the reaction gas G1 constantly.

The process gas supply unit 400 may additionally supply process gas G₃ that is mixed with the reaction gas G₁ discharged from the reactor 100 as shown in FIG. 11. The process gas G₃ according to an embodiment may include inert gas that does not chemically react with the reaction gas G₁ or any other process gas that is used in the process unit 20. For example, the carrier gas G₂ may include one or more of nitrogen, oxygen, or air. The process gas G₃ may be arranged to be mixed with the reaction gas G₁ outside the reactor 100. A second opening/closing valve 720 for blocking and releasing the supply of the process gas G₃ may be disposed with the process gas supply unit 400. The opening/closing of the second opening/closing valve 720 according to an embodiment may be controlled by the controller 500 which will be described below.

The controller 500 is a control apparatus that controls the operation of the heater 110 and the gas pump 320 and is capable of controlling the time for blocking and releasing of the first to third opening/closing valves 710, 720, and 730. In an embodiment, the controller 500 may include a user interface including a processor for controlling the overall functions and operations of the gas supply unit 41, a program for the operation of the gas supply unit 41, a memory in which data required for the operation is stored, and an input unit and an output unit.

The concentration measuring unit 600 is a measuring apparatus capable of delivering the concentration information of the reaction gas G₁ to the controller 500 after measuring the concentration of the reaction gas G₁ discharged from the reactor 100. Here, the concentration information of the reaction gas G₁ refers to concentration information of the reaction gas G₁ in the form of gas vaporized from the reactant M among all the gases passing through the gas discharging unit 130. Any measuring apparatus capable of measuring the concentration of the reaction gas G₁ in gas form may be used for the concentration measuring unit 600.

A method of operating the second supplier including the gas supply unit according to an embodiment is as follows.

According to an embodiment, the reactant M including at least one of a solid-type volatile material or a liquid-type volatile material may be disposed inside the reactor 100. For example, the heater 110 may be disposed below the reactor 100, and the reactant M may be disposed above the heater 110. The solid-type reactant M disposed in the reactor 100 may be any suitable material capable of being vaporized by receiving heat from the heater 110. The reactant M according to an embodiment may be provided in powder form to be easily vaporized. For example, the reactant M may be ρ-formaldehyde in powder form.

Next, heat may be applied to the reactant M to generate reaction gas G₁. For example, when heat is applied to the solid-type reactant M by using the heater 110, the solid-type reactant M may be vaporized to generate reaction gas G₁ in gas form. Here, the interior of the reactor 100 may be sealed until the concentration of the reaction gas G₁ exceeds a target concentration. For example, all the first opening/closing valve 710 connected to the carrier gas supply unit 200, the second opening/closing valve 720 connected to the process gas supply unit 400, and the third opening/closing valve 730 connected to the process unit 20 may be controlled by the controller 500 to be closed.

Next, carrier gas G₂ may be supplied into the reactor 100. For example, when the concentration of the reaction gas G₁ exceeds a target concentration, the carrier gas G₂ may be supplied into the reactor 100. In an embodiment, the closing of the first opening/closing valve 710 connected to the carrier gas supply unit 200 may be opened by the controller 500, and accordingly, the carrier gas G₂ may be supplied into the reactor 100. The carrier gas G₂ according to an embodiment may include an inert gas that does not chemically react with the reaction gas G₁. For example, the carrier gas G₂ may include one or more of nitrogen, oxygen, or air.

Next, a pumping pressure may be applied into the reactor 100 by operating the gas pump 320. In an embodiment, the heater 110 may be disposed below the reactor 100, and the solid-type reactant M may receive heat from the heater 110. Accordingly, the concentration of the reaction gas G₁ sensed in a bottom portion of the reactor 100 may be greater than the concentration of the reaction gas G₁ sensed in an upper portion of the reactor 100. Here, the concentration of the reaction gas G₁ discharged through the gas discharging unit 130 may not be constant. The gas pump 320 according to an embodiment may circulate the reaction gas G₁ by applying a pumping pressure to the upper portion of the reactor 100. Accordingly, in the upper portion where the reaction gas G₁ circulates, the concentration of the reaction gas G₁ may be controlled relatively constant.

Next, the concentration of the reaction gas G₁ may be measured. In an embodiment, the concentration measuring unit 600 may measure the concentration of the reaction gas G₁ discharged from the reactor 100. Here, a target concentration measured by the concentration measuring unit 600 refers to a concentration of reaction gas G₁ generated by vaporizing the reactant M. When the concentration of the reaction gas G1 is maintained substantially equal to the target concentration, the concentration measuring unit 600 may deliver the concentration information of the reaction gas G1 to the controller 500. Here, the controller 500 may transmit a control signal to the gas pump 320 to maintain the pumping pressure of the gas pump 320 constantly. In addition, the reaction gas G₁ discharged from the reactor 100 may be transferred to the process unit 20.

Next, the pumping pressure may be adjusted according to a change in the concentration of the reaction gas G₁. In an embodiment, when the concentration of the reaction gas G₁ discharged from the reactor 100 changes differently from the target concentration, the concentration measuring unit 600 may deliver the concentration information of the reaction gas G₁ to the controller 500. Here, the controller 500 may transmit a control signal to the gas pump 320 to maintain the pumping pressure of the gas pump 320 constantly. For example, when the concentration of the reaction gas G₁ is not constant, the controller 500 may control the gas pump 320 to increase the pumping pressure of the gas pump 320.

Next, the process gas G₃ may be supplied. In an embodiment, process gas G₃ that is mixed with the reaction gas G₁ discharged from the reactor 100 may be additionally supplied. The process gas G₃ according to an embodiment may include inert gas that does not chemically react with the reaction gas G₁ or any other process gas that is used in the process unit 20. For example, the carrier gas G₂ may include one or more of nitrogen, oxygen, or air. The second opening/closing valve 720 for blocking and releasing the supply of the process gas G₃ may be disposed in the process gas supply unit 400. Depending on the need of the process gas G₃, the controller 500 may control the opening/closing of the second opening/closing valve 720.

Next, the reaction gas G₁ may be transferred to the process unit 20. In an embodiment, the reaction gas G₁ having a constant concentration may be transferred to the process unit 20. Accordingly, the process unit 20 may perform a predetermined process by using the reaction gas G₁.

Hereinafter, Examples and Comparative Examples of the disclosure will be described. However, Examples below are only examples of the disclosure, and the disclosure is not limited thereto.

### EXAMPLES

### Example 1: Ag₂O—B₂O₃/TiO₂ Photocatalyst

Using an impregnation method, Ag₂O—B₂O₃/TiO₂ photocatalyst was synthesized as follows.

### Preparation of First Mixture

Based on 100 parts by weight of anatase TiO₂ (ST-01, ISHIHARA SANGYO KAISHA, LTD.), 1.0 parts by weight of AgNO₃ (available from Sigma) and 1.0 parts by weight of B₂O₃ (available from Sigma) were mixed with distilled water, and then stirred overnight at 110° C. until the water evaporated, so as to prepare a first mixture (powder). Heat treatment of first mixture

The first mixture was heat-treated at 450° C. for 2 hours (rate of temperature increase: 5° C./min), and the resulting product was ground with a mortar to prepare a Ag₂O—B₂O₃/TiO₂ photocatalyst including, based on 100 parts by weight of TiO₂, 1.0 parts by weight of B₂O₃ and 1.0 parts by weight of Ag₂O.

### Comparative Example 1: TiO₂ Photocatalyst

An anatase TiO₂ (ST-01, ISHIHARA SANGYO KAISHA, LTD.) photocatalyst was prepared.

### Comparative Example 2: Ag₂O/TiO₂ Photocatalyst

A Ag₂O/TiO₂ photocatalyst including 1.0 parts by weight of Ag₂O based on 100 parts by weight of TiO₂ was prepared in the same manner as in Example 1, except that, in the preparation of the first mixture, B₂O₃ was not used.

### Comparative Example 3: B₂O₃/TiO₂ Photocatalyst

A B₂O₃/TiO₂ photocatalyst including 1.0 parts by weight of B₂O₃ based on 100 parts by weight of TiO₂ was prepared in the same manner as in Example 1, except that, in the preparation of the first mixture, AgNO₃ was not used.

### Comparative Example 4: High-Temperature Heat-Treated Ag₂O—B₂O₃/TiO₂ Photocatalyst

A Ag₂O—B₂O₃/TiO₂ photocatalyst including, based on 100 parts by weight of TiO₂, 1.0 parts by weight of B₂O₃ and 1.0 parts by weight of Ag₂O was prepared in the same manner as in Example 1, except that, in the preparation of the first mixture, the temperature at which the first mixture is heat-treated was changed to 620° C.

TABLE 1

| | | | Composition of | |
|---|---|---|---|---|
| | | | photocatalyst | |
| | | Temperature | (TiO₂, based on 100 | |
| | | for heat | parts by weight) | |
| | | treatment of | B₂O₃ | Ag₂O |
| | | first mixture | (parts by | (parts by |
| | Photocatalyst | (° C.) | weight) | weight) |
| Example 1 | Ag₂O—B₂O₃/TiO₂ | 450 | 1.0 | 1.0 |
| Comparative | TiO₂ | — | — | — |
| Example 1 | | | | |
| Comparative | Ag₂O/TiO₂ | 450 | — | 1.0 |
| Example 2 | | | | |
| Comparative | B₂O₃/TiO₂ | 450 | 1.0 | — |
| Example 3 | | | | |
| Comparative | High-temperature heat-treated | 620 | 1.0 | 1.0 |
| Example 4 | Ag₂O—B₂O₃/TiO₂ | | | |

### Analysis Example 1: XPS Analysis

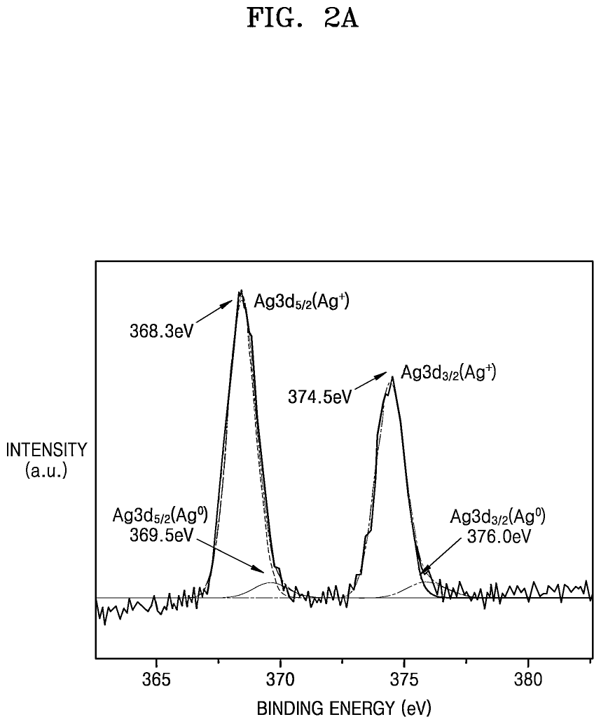

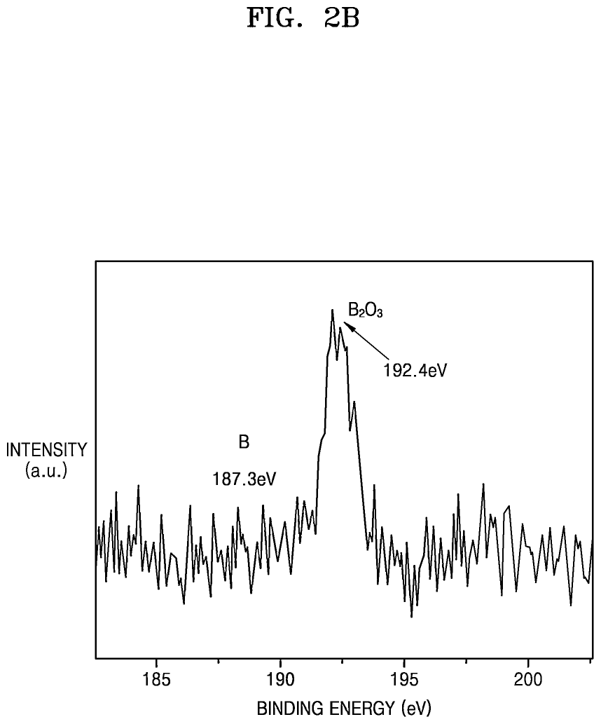

For the Ag₂O—B₂O₃/TiO₂ photocatalyst prepared in Example 1, X-ray photoelectron spectroscopy (XPS) analysis was performed to determine the oxidation number of silver and the shape of boron. The XPS analysis was performed using Quantum 2000 (Physical Electronics. Inc.). The results of the XPS analysis are shown in FIGS. 2A and 2B.

Referring to FIG. 2A, it was confirmed that Ag of the Ag₂O—B₂O₃/TiO₂ photocatalyst prepared in Example 1 exists in the form of Ag+ with an oxidation number of +1, based on the Ag3d main peak with binding energy of about 368.3 electronvolts (eV) and the Ag3d main peak about 374.5 eV binding energy.

Referring to FIG. 2B, it was confirmed that B of the Ag₂O—B₂O₃/TiO₂ photocatalyst prepared in Example 1 exists in the form of B₂O₃ rather than B, based on the B₂O₃ main peak with binding energy of about 192.4 eV.

### Analysis Example 2: TEM Analysis

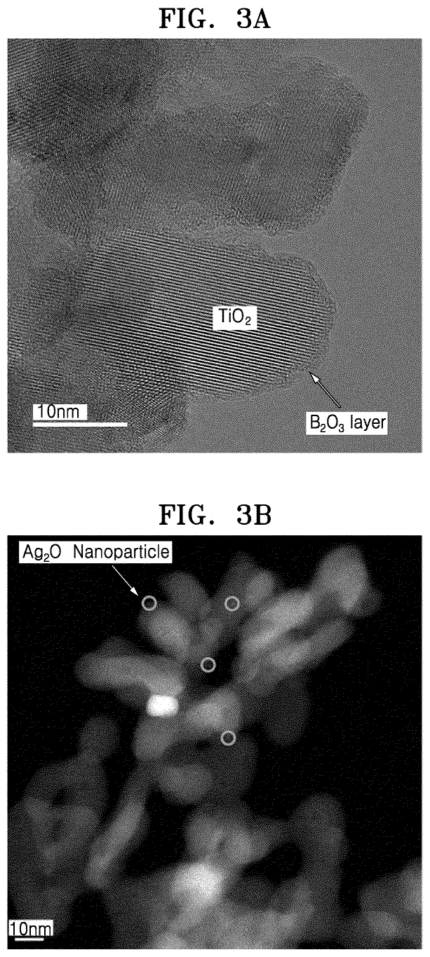

Transmission electron microscopy (TEM) analysis was performed on the Ag₂O—B₂O₃/TiO₂ photocatalyst prepared in Example 1. For the TEM analysis, a product of JEOL company was used. The results of the TEM analysis are shown in FIGS. 3A and 3B.

Referring to FIG. 3A, it was confirmed that a boron oxide layer (B₂O₃ layer) was formed on the surface of TiO₂ of the Ag₂O—B₂O₃/TiO₂ photocatalyst prepared in Example 1.

Referring to FIG. 3B, it was confirmed that Ag₂O particles were distributed on the surface of TiO₂ of the Ag₂O—B₂O₃/TiO₂ photocatalyst prepared in Example 1.

### Analysis Example 3: ICP Analysis

The Ag₂O/TiO₂ photocatalyst prepared in Comparative Example 2 and the Ag₂O—B₂O₃/TiO₂ photocatalyst prepared in Example 1 were each added to distilled water, sonicated for 30 minutes, stirred overnight, and filtered. The filtrate was dried at 100° C., and the resulting powder was ground with a mortar. Then, inductively coupled plasma (ICP) analysis was performed for Ag in the powder of each photostability by using a product of SHIMADZU Company, so as to evaluate the supporting intensity of Ag₂O, i.e., the catalyst stability.

As a result of the ICP analysis, it was confirmed that the amount of Ag in the powder of the Ag₂O/TiO₂ photocatalyst prepared in Comparative Example 2 was 0.35 weight percent (wt %), and the amount of Ag in the powder of the Ag₂O—B₂O₃/TiO₂ photocatalyst prepared in Example 1 was 0.69 wt %.

Accordingly, it was confirmed that, due to the B₂O₃ layer of the Ag₂O—B₂O₃/TiO₂ photocatalyst prepared in Example 1, the binding force between TiO₂ and Ag₂O was strengthened and the supporting intensity of the Ag₂O was accordingly improved.

### Analysis Example 4: XRD Analysis

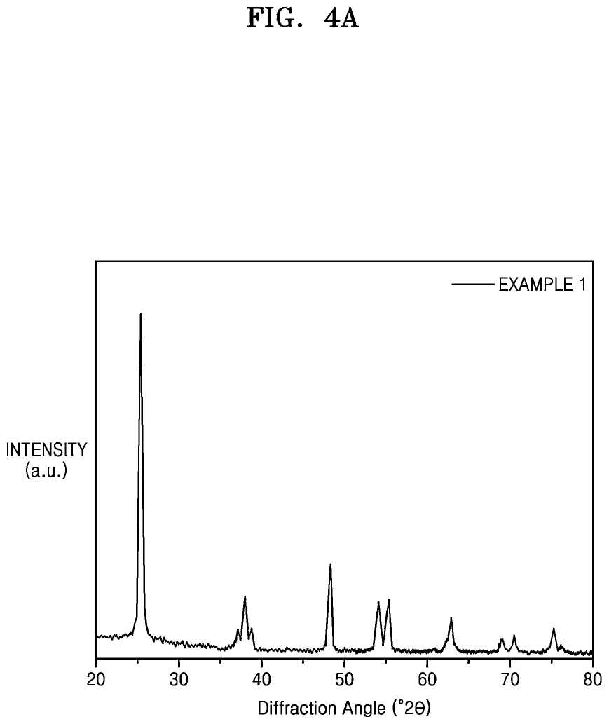

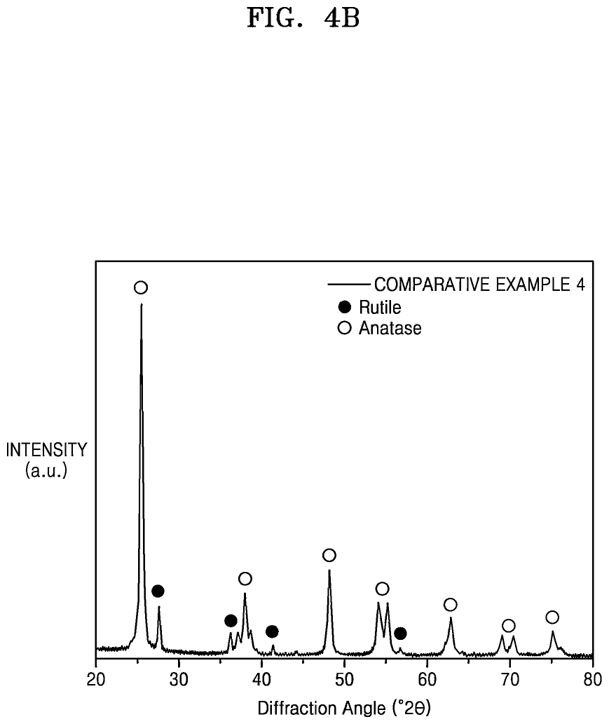

For each of the Ag₂O—B₂O₃/TiO₂ photocatalyst prepared in Example 1 (heat-treated at 450° C.) and the Ag₂O—B₂O₃/TiO₂ photocatalyst prepared in Comparative Example 4 (heat-treated at 620° C.), X-Ray diffraction (XRD) analysis was performed using an XRD device of Bruker Company, and the results are shown in FIGS. 4A and 4B, respectively.

Referring to FIG. 4A, it was confirmed that most of the TiO₂ of the Ag₂O—B₂O₃/TiO₂ photocatalyst prepared in Example 1 (heat-treated at 450° C.) existed in the form of anatase TiO₂, whereas, referring to FIG. 4B, most of the TiO₂ of the Ag₂O—B₂O₃/TiO₂ photocatalyst prepared in Comparative Example 4 (heat-treated at 620° C.) exist in the form of rutile TiO₂.

### Analysis Example 5: Emission Spectrum and UV-Visible Spectrum (Kubelka-Munck-Function) Analysis

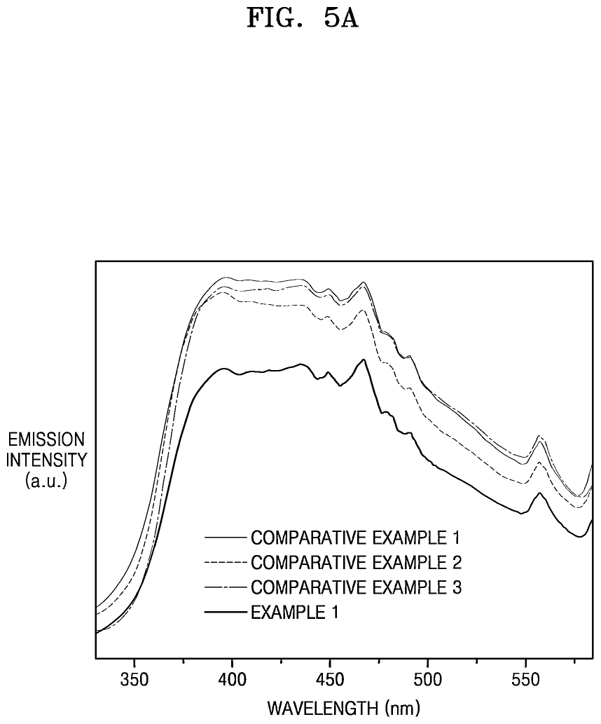

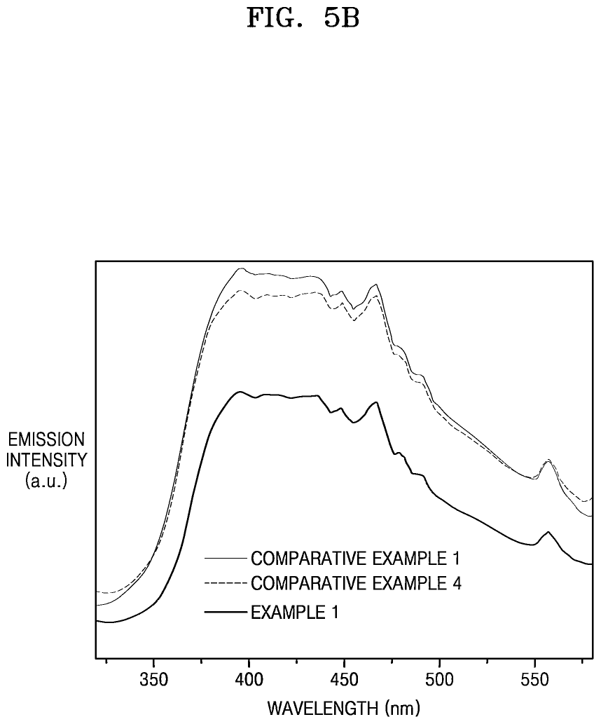

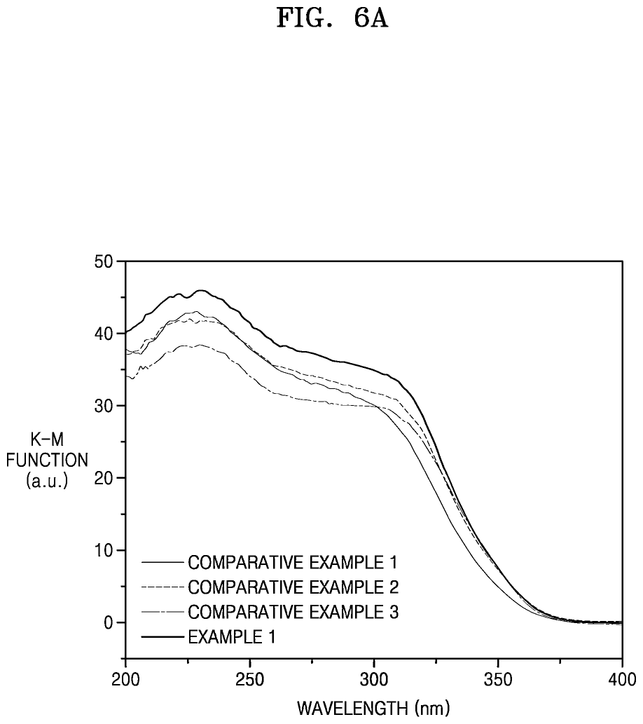

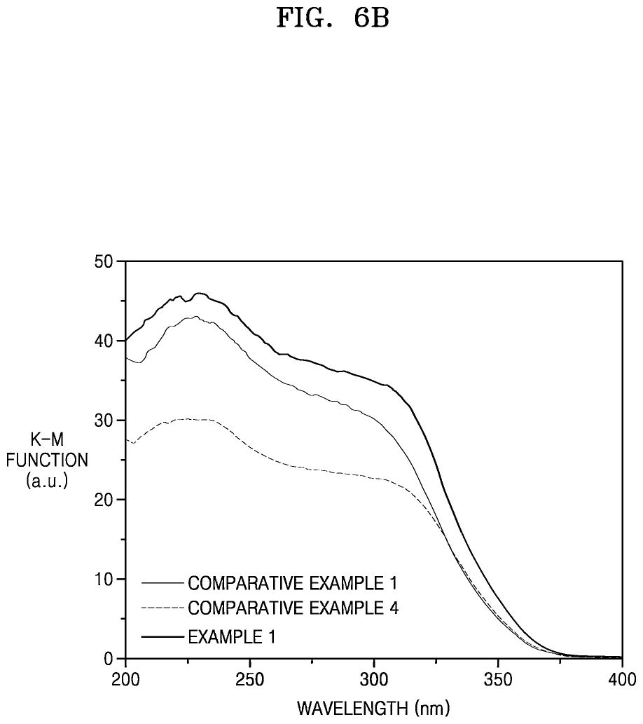

Each of the Ag₂O—B₂O₃/TiO₂ photocatalyst prepared in Example (heat-treated at 450° C.), the TiO₂ photocatalyst prepared in Comparative Example 1, the Ag₂O/TiO₂ photocatalyst prepared in Comparative Example 2, the B₂O₃/TiO₂ photocatalyst prepared in Comparative Example 3, and the Ag₂O—B₂O₃/TiO₂ photocatalyst prepared in Comparative Example 4 (heat-treated at 620° C.) was pressed and fixed in a holder, and the emission spectra and UV-visible spectra thereof were measured. The emission spectra and UV-visible spectra were recorded with FluoroMax (manufactured by HORIBA Inc.) and UV-2600i (manufactured by SHIMADZU Inc.), respectively. The results of the emission spectrum analysis are shown in FIG. 5A (Example 1, Comparative Example 1, Comparative Example 2, and Comparative Example 3) and FIG. 5B (Example 1, Comparative Example 1, and Comparative Example 4). The absorbance for each wavelength obtained through the UV-visible spectrum analysis was substituted into the Kubelka-Munk equation, and the results are shown in FIG. 6A (Example 1, Comparative Example 1, Comparative Example 2, and Comparative Example 3) and FIG. 6B (Example 1, Comparative Example 1, and Comparative Example 4).

Referring to FIGS. 5A and 5B, it was confirmed that the emission intensity of the Ag₂O—B₂O₃/TiO₂ photocatalyst prepared in Example 1 (heat-treated at 450° C.) was lower than the emission intensity of each of the TiO₂ photocatalyst prepared in Comparative Example 1, the Ag₂O/TiO₂ photocatalyst prepared in Comparative Example 2, the B₂O₃/TiO₂ photocatalyst prepared in Comparative Example 3, and the Ag₂O—B₂O₃/TiO₂ photocatalyst prepared in Comparative Example 4 (heat-treated at 620° C.). Accordingly, it is understood that the recombination of electrons and holes was effectively reduced by the synergistic effect of Ag₂O and B₂O₃ in the Ag₂O—B₂O₃/TiO₂ photocatalyst prepared in Example 1 (heat-treated at 450° C.).

Referring to FIGS. 6A and 6B, it was confirmed that the absorbance of the Ag₂O—B₂O₃/TiO₂ photocatalyst prepared in Example 1 (heat-treated at 450° C.) in the ultraviolet wavelength region of 200 nm to 400 nm was greater than the absorbance of each of the TiO₂ photocatalyst prepared in Comparative Example 1, the Ag₂O/TiO₂ photocatalyst prepared in Comparative Example 2, the B₂O₃/TiO₂ photocatalyst prepared in Comparative Example 3, and the Ag₂O—B₂O₃/TiO₂ photocatalyst prepared in Comparative Example 4 (heat-treated at 620° C.), and accordingly, it is understood that the absorbance was improved by the synergistic effect of Ag₂O and B₂O₃ in the Ag₂O—B₂O₃/TiO₂ photocatalyst prepared in Example 1 (heat-treated at 450° C.).

### Evaluation Example 1: Evaluation of Toluene Removal Efficiency

For each of the Ag₂O—B₂O₃/TiO₂ photocatalyst prepared in Example 1 (heat-treated at 450° C.), the TiO₂ photocatalyst prepared in Comparative Example 1, the Ag₂O/TiO₂ photocatalyst prepared in Comparative Example 2, and the B₂O₃/TiO₂ photocatalyst prepared in Comparative Example 3, the toluene removal efficiency (%) was evaluated according to a method of measuring a decrease in the initial concentration using a continuous temperature-rising reactor, and the results are shown in Table 2. Here, the initial concentration of toluene in the continuous temperature-rising reactor was 70 parts per million (ppm), and the gas hourly space velocity (GHSV, flow rate of toluene per unit time divided by volume of the substance) for each substance was adjusted to be 30,000 hour⁻¹. The toluene removal efficiency (%) was evaluated according to Expression 1:

(Initial concentration of toluene−concentration of discharged toluene)/initial concentration of toluene*100% Expression 1

TABLE 2

| | | Toluene removal efficiency |
|---|---|---|
| | Photocatalyst | (%) |
| Example 1 | Ag₂O—B₂O₃/TiO₂ | 63 |
| Comparative | TiO₂ | 53 |
| Example 1 | | |
| Comparative | Ag₂O/TiO₂ | 47 |
| Example 2 | | |
| Comparative | B₂O₃/TiO₂ | 37 |
| Example 3 | | |

Referring to Table 2, it was confirmed that the toluene removal efficiency % of the Ag₂O—B₂O₃/TiO₂ photocatalyst prepared in Example 1 (heat-treated at 450° C.) was greater than the toluene removal efficiency % of each of the TiO₂ photocatalyst prepared in Comparative Example 1, the Ag₂O/TiO₂ photocatalyst prepared in Comparative Example 2, and the B₂O₃/TiO₂ photocatalyst prepared in Comparative Example 3.

According to the one or more embodiments, a photocatalyst may have improved light absorption in the ultraviolet region, high removal efficiency of volatile organic compounds (VOCs), and excellent stability, and thus may be applicable to an air purification system for removal of VOCs.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A photocatalyst comprising:
boron oxide;
a first metal oxide, wherein the first metal oxide is an oxide of a first metal; and
a core including anatase,
wherein the boron oxide and the first metal oxide are disposed on a surface of the core, and
an oxidation number of at least one of the first metals is +1.

2. The photocatalyst of claim 1, wherein the boron oxide comprises B₂O₃.

3. The photocatalyst of claim 1, wherein the boron oxide is disposed on the surface of the core, in the form of a boron oxide layer covering at least a portion of the surface of the core.

4. The photocatalyst of claim 3, wherein the boron oxide layer comprises crystalline boron oxide.

5. The photocatalyst of claim 3, wherein the first metal oxide is disposed on a surface of the boron oxide layer.

6. The photocatalyst of claim 1, wherein the core further comprises the boron oxide.

7. The photocatalyst of claim 1, wherein an amount of the boron oxide is in a range of about 0.1 part by weight to about 5.0 parts by weight, based on 100 parts by weight of the core.

8. The photocatalyst of claim 1, wherein the first metal comprises copper, platinum, gold, silver, zinc, manganese, or a combination thereof.

9. The photocatalyst of claim 1, wherein the first metal oxide comprises Cu₂O, Pt₂O, Au₂O, Ag₂O, Zn₂O, Mn₂O, or a combination thereof.

10. The photocatalyst of claim 1, wherein an amount of the first metal oxide is in a range of about 0.1 part by weight to about 5.0 parts by weight, based on 100 parts by weight of the core.

11. The photocatalyst of claim 1, wherein the first metal oxide and the core are independently in the form of a particle, wire, cluster, crystal, or a combination thereof.

12. The photocatalyst of claim 1, wherein
the first metal oxide is a primary particle having a first size of about 5 nanometers to about 10 nanometers, and
the core is a primary particle having a second size of about 0.1 nanometer to about 20 nanometers or a secondary particle having a third size of about 10 nanometers to about 200 nanometers.

13. The photocatalyst of claim 1, wherein the photocatalyst is effective for decomposition and removal of a volatile organic compound.

14. A method of preparing the photocatalyst of claim 1, the method comprising:
preparing a first mixture comprising a boron-containing precursor, a first metal-containing precursor, and anatase; and
heat-treating the first mixture to prepare the photocatalyst of claim 1.

15. The method of claim 14, wherein the heat-treating of the first mixture comprises heating at about 450° C. to about 500° C.

16. The method of claim 15, wherein
the boron-containing precursor comprises boron oxide, and
during the heat-treating of the first mixture,
an anatase crystalline phase of the anatase contained in the first mixture is substantially maintained, and
a liquid boron oxide produced by melting at least a portion of the boron oxide is crystallized to cover at least a portion of a surface of the core comprising the anatase to form a boron oxide layer covering the at least the portion of the surface of the core.

17. A catalyst filter comprising:
a porous ceramic support; and
the photocatalyst of claim 1 disposed on a surface of the porous ceramic support.

18. The catalyst filter of claim 17, wherein the porous ceramic support has a honeycomb structure.

19. An air purification system comprising:
a supplier configured to supply air comprising a volatile organic compound; and
an air purifier comprising a catalyst module configured to decompose and remove the volatile organic compound from the air supplied from the supplier and discharge the air from which the volatile organic compound has been decomposed and removed,
wherein the catalyst module comprises
the catalyst filter of claim 17, and
an energy supply source disposed on the catalyst filter to supply energy to the catalyst filter to activate the photocatalyst.

20. The air purification system of claim 19, wherein the volatile organic compound comprises gaseous formaldehyde, gaseous ammonia, gaseous acetaldehyde, gaseous acetic acid, gaseous toluene, or a combination thereof.
